(19) United States
(12) Patent Application Publication
(10) Pub. No.: US 2013/0311545 A1
(43) Pub. Date: Nov. 21, 2013

(54) Emergency Event Management System

(71) Applicant: Bandwidth.com, Inc., Raleigh, NC (US)

(72) Inventors: Earl Wright, Cary, NC (US); Brad Roldan, Sunnyvale, CA (US); Shaw Terwilliger, Durham, NC (US); Jason Sommerset, Mt Hood Parkdale, OR (US)

(21) Appl. No.: 13/944,977

(22) Filed: Jul. 18, 2013

(51) Int. Cl. H04L 29/08

(52) U.S. Cl. CPC H04L 67/10
USPC 709/202

(57) ABSTRACT

Techniques to manage an unplanned event are described. A system includes a processor component, a communications interface component, an event definition component and an event management component. The communications interface component may be operative to establish a bridge connection among a plurality of communication devices. The event definition component may be operative on the processor component to define the parameters of an event, the event indicative of an unplanned happening. The event management component may be operative on the processor component to recognize a triggering of the event and cause the communications interface component to establish the bridge connection among the plurality of communication devices upon the triggering of the event. Other embodiments are described and claimed.

### BACKGROUND

A wide variety of emergency events can impact an enterprise's ability to carry out its business and meet the need of its clients. When such an event occurs the enterprise needs to quickly set up communication among key personnel to begin assessing and dealing with the effects of the event and coordinating a solution or resolution. Coordinating the rapid communication among these key participants presents a challenge since the emergency event, by definition, was not planned.

What is needed is an event driven communication initiation system to connect key personnel rapidly and automatically when an emergency event occurs.

### SUMMARY

Various embodiments are generally directed to techniques to manage an unplanned event. In one embodiment, a system includes a processor component, a communications interface component, an event definition component and an event management component. The communications interface component may be operative to establish a bridge connection among a plurality of communication devices. The event definition component may be operative on the processor component to define the parameters of an event, the event indicative of an unplanned happening. The event management component may be operative on the processor component to recognize a triggering of the event and cause the communications interface component to establish the bridge connection among the plurality of communication devices upon the triggering of the event. Other embodiments are described and claimed.

In another embodiment, the event definition component operative on the processor component may be further operative to: create a unique identifying label for the event; determine a priority level for the event; associate at least one condition that would trigger the event; and determine a plurality of participants associated with the event.

In another embodiment, the event definition component operative on the processor component may be further operative to: assign a participation role for each participant for each priority level of the event; determine at least one contact number for each participant, the contact number associated with a communications device; and when a participant has more than one contact number, determining a priority contact order for the contact numbers.

In another embodiment, the participant role may be chosen from a set comprising a required participant, an optional participant, an event commander, and a notification only participant.

In another embodiment, the contact options for a notification only participant may include email, text message, and voice mail.

In another embodiment, the event definition component operative on the processor component may be further operative to receive participant self enrollment data for an event. The self enrollment data may comprise the unique identifying label for the event, a participation role for each participant for each priority level of the event, at least one contact number, and when there are more than one contact numbers, a priority contact order for the contact numbers.

In another embodiment, the event management component operative on the processor component may be further operative to: receive real-time data from participants, the data pertaining to the event; receive real-time suggestions from participants, the suggestions pertaining to a resolution of the event; create real-time status updates pertaining to a resolution of the event; and cause the display of the real-time data from participants, real-time suggestions from participants and real-time status updates on a display accessible to all participants utilizing a communications device that includes a display.

In another embodiment, a feedback component may be operative on the processor component to: compare previous events stored in memory to the event; determine if any previous events are similar to the event; cause the display of a relevance ranked list of previous events based on similarity to the event; receive a selection of one of the listed previous events; and cause the display of stored suggestions and data pertaining to a resolution of the selected previous event.

In another embodiment, the feedback component operative on the processor component may be further operative to: compare previous events stored in memory to the event each time a new real-time suggestion is received or real-time status update is generated; and cause the display of an updated relevance ranked list of previous events based on similarity to the event.

In another embodiment, the communications devices may include at least one from a set comprising mobile terminals, Voice-over Internet Protocol (VoIP) phones, personal computers, laptop computers, tablet computers, and Plain Old Telephone Service (POTS) phones.

Certain illustrative aspects are described herein in connection with the following description and the annexed drawings. These aspects may be indicative of the various ways in which the principles disclosed herein can be practiced. In addition, these aspects and any equivalents are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a block diagram of an embodiment of a system to manage an emergency event.

FIG. 2 illustrates a block diagram of a network computer server according to an embodiment.

FIG. 3 illustrates a logic flow.

FIG. 4 illustrates a logic flow.

FIG. 5 illustrates a logic flow.

FIG. 6 illustrates a logic flow.

FIG. 7 illustrates a logic flow.

FIG. 8 illustrates an embodiment of a computer screen image for main window.

FIG. 9 illustrates an embodiment of a computer screen image for defining an event.

FIG. 10A illustrates an embodiment of a computer screen image for adding a participant to an event.

FIG. 10B illustrates another embodiment of a computer screen image for adding a participant.

FIG. 11 illustrates an embodiment of a computer screen image for a command window for use in managing an event.

FIG. 12 illustrates an embodiment of a computer screen image for a participant window for use in managing an event.

FIG. 13 illustrates an embodiment of a computer screen image for a feedback window for use in managing an event.

FIG. 14 illustrates an embodiment of a computing architecture.

### DETAILED DESCRIPTION

Various embodiments described herein may be implemented as part of an Emergency Event Management System (EEMS). EEMS may be a browser-based tool operative on a variety of end user devices, local computer servers, and/or cloud based servers connected via one or more computer network platforms. The end user communication devices may include, without limitation, desktop computers, personal computers (PCs), laptop or notebook computers, tablet style computers, and mobile devices (e.g., smartphones) and even plain old telephone service (POTS) phones.

EEMS permits users to define events before they happen and craft an automatic response when such events do happen. One feature is the ability to link multiple participants to an event. Participants may be chosen (or may self-enroll) based on their expertise or knowledge of the event if it happens. When the event is triggered and detected, EEMS will automatically establish a communications bridge among the participants associated with the event. As a result, the establishment of the communications bridge is event driven.

Events may be defined and associated with one or more triggering conditions. When the triggering conditions are satisfied, EEMS initiates the communications bridge among the participants. One of the participants may be designated as the event commander. The event commander may act as a coordinator of information gathering and dissemination. The event commander may post status updates and organize participant input (e.g., data or suggestions) on a shared electronic whiteboard. Thus, the event commander can make sure that all participants (those with computer network access and a display) receive real-time updates of the event.

Another feature is the ability to store and access previous events and their updates and outcomes. When a new event occurs, the event commander may conduct a search for previous similar events. The event commander may select one or more of the search results and share with the present participants. The actions taken in the previous event may lead to a faster resolution of the present event.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

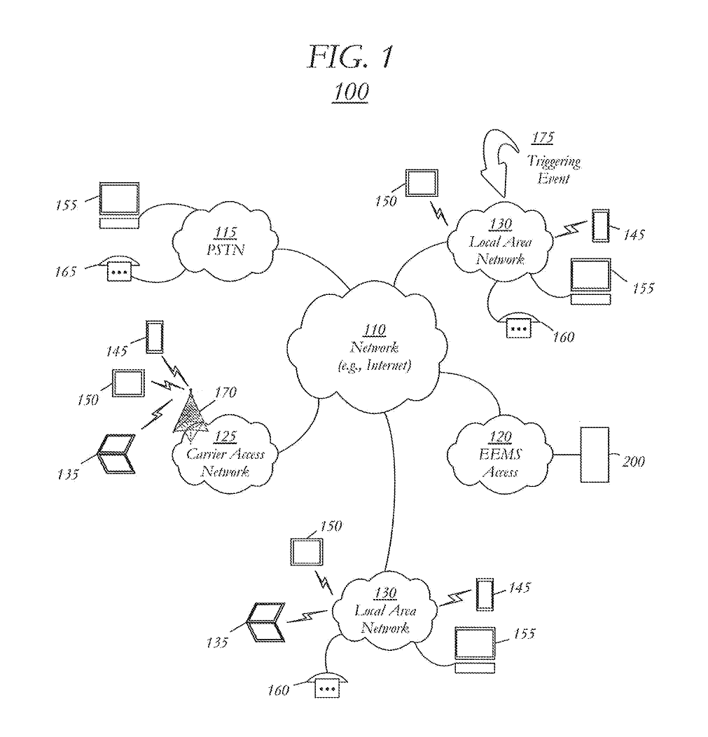

FIG. 1 illustrates a block diagram of an embodiment of a system infrastructure to facilitate management of an emergency event. For purposes of illustration, the system infrastructure may be referred to as an Emergency Event Management System (EEMS) 100. In one embodiment, the EEMS 100 may comprise a computer-implemented system having one or more components. Although the EEMS 100 shown in FIG. 1 has a limited number of elements in a certain topology, it may be appreciated that the EEMS 100 may include more or less elements in alternate topologies as desired for a given implementation.

The EEMS 100 may be embodied as a collection of end user communication devices having access to a variety of networks that are linked together and under the control of an EEMS server 200. The EEMS server 200 may be associated with an EEMS access network 120 that is in communications with and accessible to a larger network 110 such as, for instance, the Internet. Other networks communicable with network 110 may include the public switched telephone network (PSTN) 115, one or more cellular carrier access network(s) 125, and one or more local area network(s) (LANs) 130. At least one of the LANs 130 may represent a corporate intra-net for a particular enterprise. In addition, the EEMS access network 120 need not necessarily be a stand-alone network and may be encompassed by such a LAN network 130.

Each of the various networks may support one or more end user communication devices. For example, the PSTN 115 may be communicable with a POTS phone 165 or a computer 155. The computer 155 may be connected to the PSTN 115 using a modem as a communications interface to allow data in addition to voice to be exchanged over the PSTN 115. The PSTN, in turn, may be communicatively coupled with the network 110. In the case of a POTS phone 165, communications may be limited to voice/audio only.

The cellular carrier access network 125 may support wireless RF communications over a variety of RF voice and data protocols with end user communications devices such as, for instance, mobile terminals 145, RF radio equipped tablet computers 150 and/or RF radio equipped laptop computers 135. A mobile terminal 145 may include, but is not limited to, a cellular telephone, a so-called smartphone, a personal digital assistant (PDA) or the like. The RF protocols may include, but are not limited to, GSM, CDMA, WCDMA, CDMA2000, GPRS, Edge, HSDPA, LTE, EVDO, HSPA, UMTS, and WiMax.

The LAN network(s) 130 may support wired (e.g., Ethernet) and wireless RF communications including, but not limited to, 802.11 and Bluetooth™. The LAN network(s) 130 may communicate with end user communications devices such as, for instance, computers 155, mobile terminals 145, tablet computers 150, laptop computers 135 and voice over IP (VoIP) phones 160.

It should be appreciated by those of ordinary skill in the art that additional network configurations and components may be implemented (e.g., wireless access points) without departing from the scope of the embodiments described herein. FIG. 1 is illustrative in nature and does not purport to capture every conceivable network or system architecture.

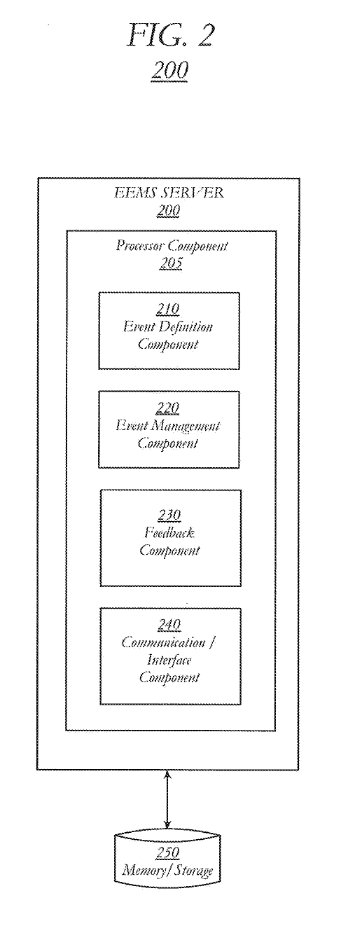

FIG. 2 illustrates a block diagram of an EEMS network computer server 200 according to an embodiment. The EEMS server 200 may be accessible via a stand-alone EEMS access network 120 or may be a part of a more generalized corporate LAN network 130. The EEMS server 200 may be functionally divided into multiple components under the control of a processor component 205. The functional components may include an event definition component 210, an event management component 220, a feedback component 230 and a communications/interface component 240. In addition, the EEMS server 200 may be in functional communication with a memory/storage component 250.

The event definition component 210 may assist in creating and defining events and event participants. The event management component 220 may assist in detecting and managing events that occur. The feedback component 230 may provide additional assistance in managing events. The communications/interface component 240 may assist in setting up and managing communications among the EEMS server and a plurality of end user communication devices.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

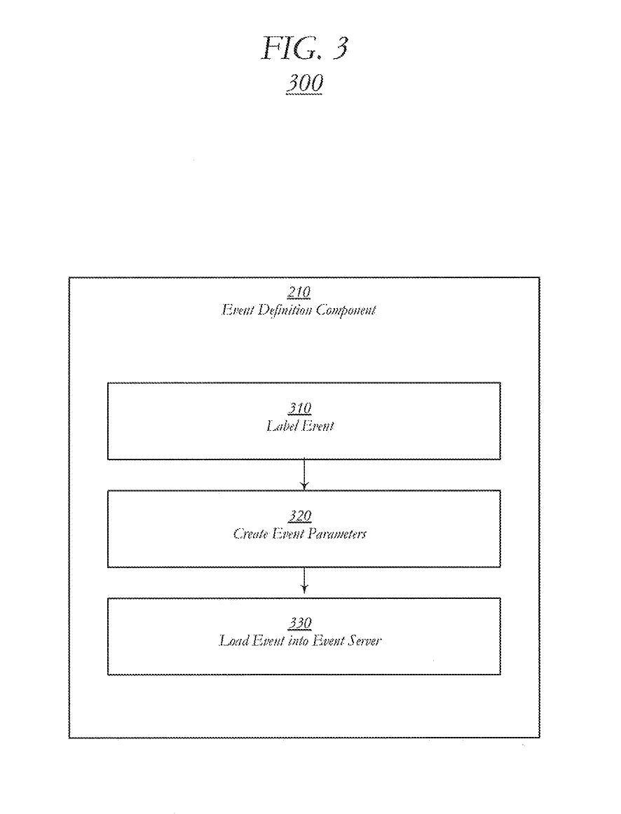

FIG. 3 illustrates one embodiment of a logic flow 300. The logic flow 300 may be representative of some or all of the operations executed by one or more embodiments described herein. In the illustrated embodiment shown in FIG. 3, the logic flow 300 may label an event at block 310. For example, a user may utilize a software interface such as, for instance, a web-based graphical user interface (GUI) to interact with the functions of the event definition component 210. The GUI may prompt the user for a unique identifier for an event. The unique identifier or label may be used to distinguish this event from all others that may exist or be created by the EEMS 100. For example, the user may create an event and label it “E-commerce Server Outage” to indicate that the event refers to a situation in which the enterprise's e-commerce servers are compromised.

In the illustrated embodiment shown in FIG. 3, the logic flow 300 may create event parameters at block 320. For example, a user may utilize the GUI to enter information describing various parameters pertaining to the event. These parameters may also be referred to as triggers. The logic flow 300 may then load events into the EEMS server 200 at block 330. For example, once an event has been defined it may be loaded into the EEMS server 200 to await a triggering condition.

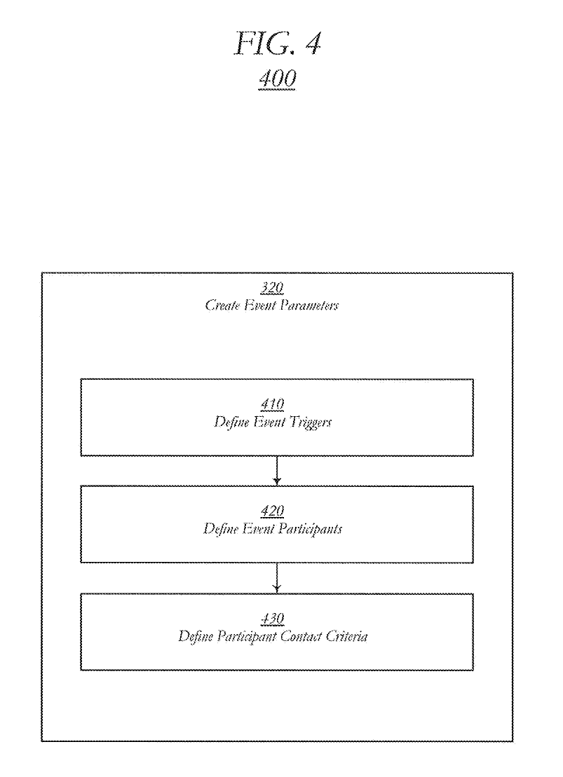

FIG. 4 illustrates one embodiment of a logic flow 400 for creating event parameters as described in block 320 of FIG. 3. The logic flow 400 may be representative of some or all of the operations executed by one or more embodiments described herein. In the illustrated embodiment shown in FIG. 4, the logic flow 400 may define event triggers at block 410. The triggers may represent situations or occurrences that precipitate or launch an event. To further the example given above, the event parameter(s) or trigger(s) for the event “E-commerce Server Outage” may include the receipt of a pre-determined number of customer complaints within a short period of time, five (5) consecutive failures of standard communications interface acknowledgements, or manual triggering. The aforementioned examples are illustrative only. Other triggers may be created and implemented based on the type and/or severity of the event.

In the illustrated embodiment shown in FIG. 4, the logic flow 400 may define event participants at block 420. For example, a user may utilize the GUI to enter personnel that should be included in a response to the event. Such personnel may be referred to as event participants. There may be multiple types of event participants ranging from event commanders (person responsible for coordinating and managing the event response) to notification only participants (personnel that have a passive role in event management).

In the illustrated embodiment shown in FIG. 4, the logic flow 400 may define participant contact criteria at block 430. For example, participant contact criteria may include one or more points or modes of contact that the EEMS server 200 may use to contact the participant.

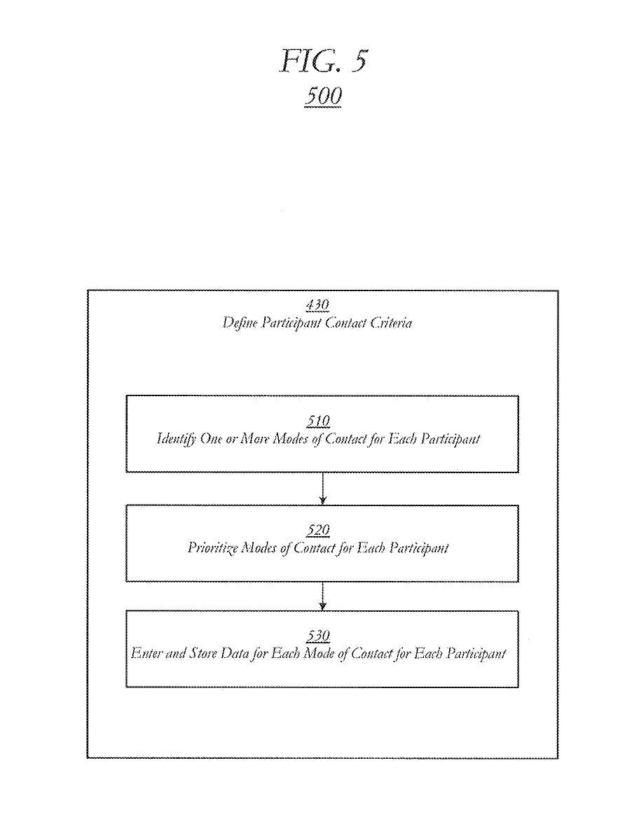

FIG. 5 illustrates one embodiment of a logic flow 500 for defining participant contact criteria in block 430 of FIG. 4. The logic flow 500 may be representative of some or all of the operations executed by one or more embodiments described herein. In the illustrated embodiment shown in FIG. 5, the logic flow 500 may identify one or more modes of contact for a participant at block 510. For example, a participant may be associated with multiple modes and/or points of contact. The modes of contact may include an office telephone number, a mobile telephone number, a home telephone number, an email address, or the like. Each point of contact may represent one or more modes of contact. An office phone number or home phone number may be reachable using a standard audio connection or may be linked to a computer to provide a richer data experience than just voice. Similarly, a mobile telephone number may be associated with a smartphone or tablet computer to provide both voice and data connection with the EEMS server 200. A participant's email address may be used as a point of contact that may be associated with a voice and/or data service capable of connecting to a bridge under control of the EEMS server 200. The participant's mobile phone number may also be used as a text messaging mode of contact as well.

In the illustrated embodiment shown in FIG. 5, the logic flow 500 may prioritize modes of contact for a participant at block 520. For example, a participant may have multiple modes of contact but the EEMS server 200 will attempt to bridge the participant using one of modes of contact. In setting up the participant, the event commander (or participant herself if self-enrolling) may specify the priority or order in which the EEMS server 200 should use in contacting and bridging the participant.

In the illustrated embodiment shown in FIG. 5, the logic flow 500 may enter and store data for each mode of contact for a participant at block 530. For example, the event commander (or participant herself if self-enrolling) may enter the appropriate contact data for the participant such that it is stored within the EEMS server 200. Upon the triggering of an event for which the participant is associated, the EEMS server 200 may contact and bridge the participant using the contact priority data previously entered.

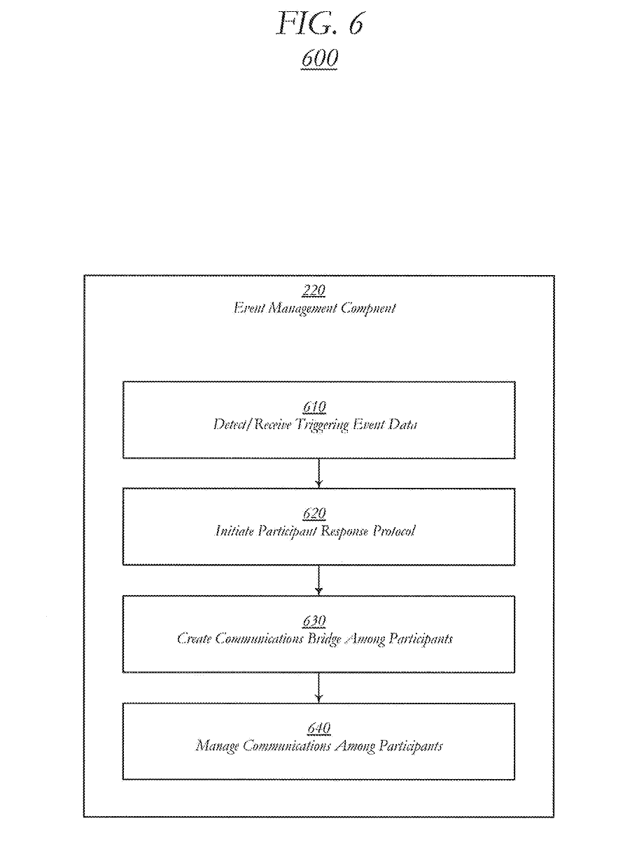

FIG. 6 illustrates one embodiment of a logic flow 600. The logic flow 600 may be representative of some or all of the operations executed by one or more embodiments described herein. In the illustrated embodiment shown in FIG. 6, the logic flow 600 may detect/receive triggering event data at block 610. For example, the EEMS server 200 may detect a triggering event by comparing received data to event trigger data previously defined when the event was set up. Each stored event is associated with one or more event triggers. When the EEMS server 200 becomes aware of a trigger that matches an event trigger it signifies the start of event management and an event response.

In the illustrated embodiment shown in FIG. 6, the logic flow 600 may initiate a participation response protocol at block 620. For example, the EEMS server may load the event associated with the event trigger. The event will be associated with one or more event participants that need to be contacted. The logic flow 600 may then create a communications bridge among participants at block 630. For example, each participant will have a prioritized list of contact points with which the EEMS server will seek to establish a centralized communications bridge so that all participants are in communications with one another without requiring the individual participants to take an active role in establish the bridge connection beyond answering a call or contact request.

In the illustrated embodiment shown in FIG. 6, the logic flow 600 may manage communications among participants at block 640. For example, once a communications bridge among the participants has been established, an event commander may utilize a software interface such as, for instance, a web-based graphical user interface (GUI) to interact with the functions of the event management component 220 to manage the receipt and presentation of data received by the EEMS server 200. The event commander may then coordinate suggestions for resolving the problem, post status updates, share the suggestions in a shared fashion, add and/or drop participants as conditions dictate, and search for previous events (and their resolutions) similar to the current event.

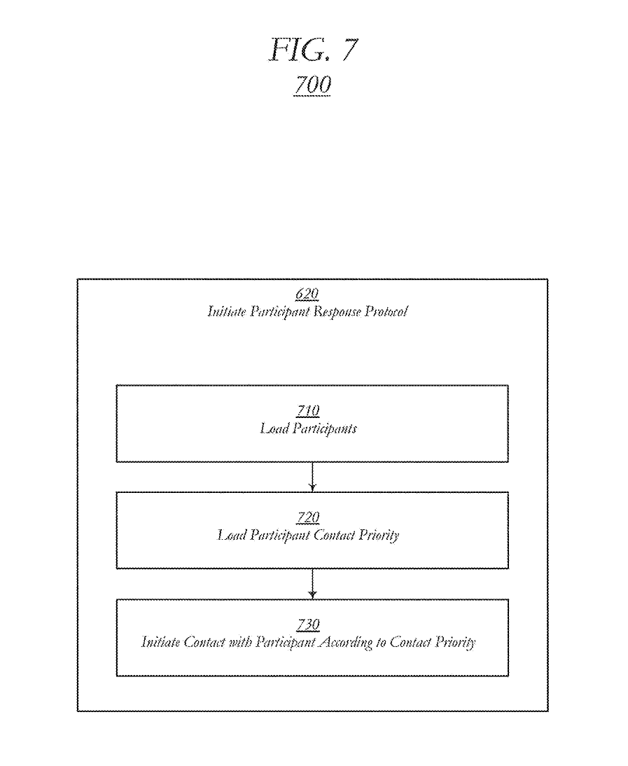

FIG. 7 illustrates one embodiment of a logic flow 700 for initiating a participant response protocol as set out in block 620 of FIG. 6. The logic flow 700 may be representative of some or all of the operations executed by one or more embodiments described herein. In the illustrated embodiment shown in FIG. 7, the logic flow 700 may load participants at block 710. For example, when the EEMS server 200 becomes aware of a trigger that matches an event trigger it signifies the start of event management and an event response. Once the event is loaded into the EEMS server 200, it then parses the event data to determine the participants associated with the event. The logic flow 700 may then load participant contact priority data at block 720. For example, each participant will have a contact profile establishing the mode and order of contact points for that participant. The EEMS server 200 will access the contact profile and attempt to establish contact with the participant based on the contact priority at block 730. For instance, a participant may have established their work phone number as the first point of contact when an event occurs followed by a mobile phone number as a secondary point of contact followed by a home phone number after that. The EEMS server does this for each required participant until a bridge connection with all the participants has been established. In the event that a participant cannot be reached at any of the specified contact points, the EEMS server 200 may re-attempt contacting the participant at specified intervals. This process may run in the background so as not to delay the management of an event for the remaining participants.

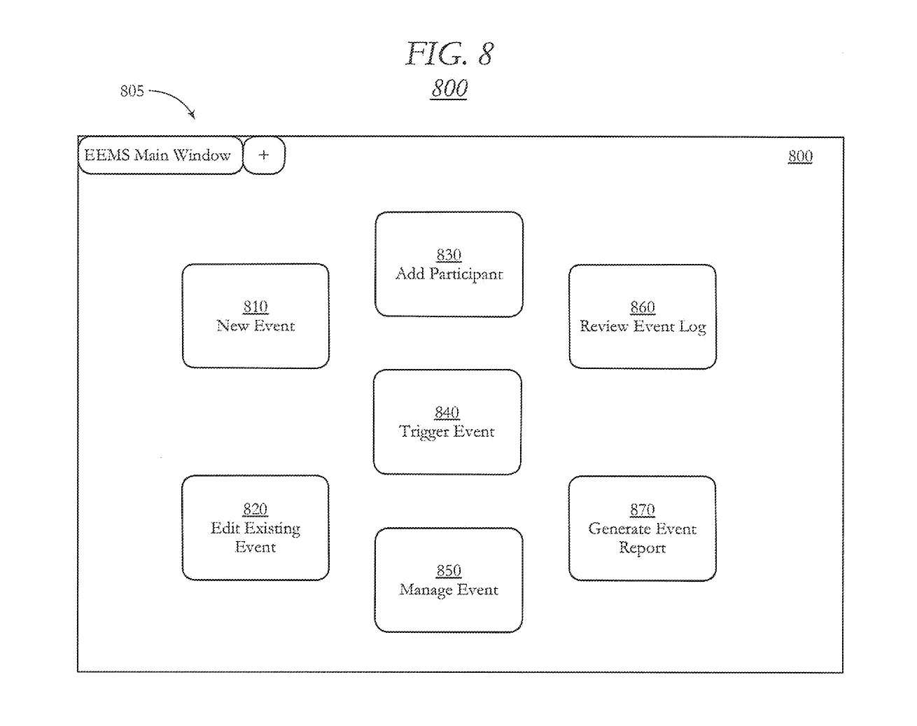

By way of example, FIGS. 8-13 illustrate sample screen shots for a GUI interface for accessing EEMS 100 to carry out the functions described in the logic flows described in FIGS. 3-7. A contrived emergency event is used to illustrate many of the functions and interactions the event commander and event participants can take in resolving the emergency event. The specific data for the contrived event should not be construed as limiting as it is merely exemplary. Those of ordinary skill in the art may readily adapt the EEMS 100 to anticipate and manage multiple events based on a variety of triggering conditions.

In addition, the look and feel of the screen shots in FIGS. 8-13 is also exemplary. Those of ordinary skill in the art may readily customize a GUI interface and achieve the same or similar results to those discussed herein. Thus, the particular arrangement of frames within the figures herein should not be construed as limiting.

FIG. 8 illustrates one example of an embodiment of a browser enabled computer screen image for a graphical user interface (GUI) operative to create, manage, and respond to emergency events. The embodiments are not limited to this example. For example, the computer screen image of the GUI does not necessarily need to be implemented via a web-browser. In this example, The EEMS main window 800 may be comprised of a plurality of functional components that include a new event component 810, an edit existing event component 820, an add participant component 830, a trigger event component 840, a manage event component 850, a review event log component 860, and a generate event report component 870. In addition, each functional component may be launched by a user navigating a cursor over the component and clicking on same. In some embodiments, the GUI may utilize a tabbed architecture such that each component when launched will open in a new tab 805. In this manner a user may keep multiple windows running and be able to switch among them by clicking on the appropriate tab 805.

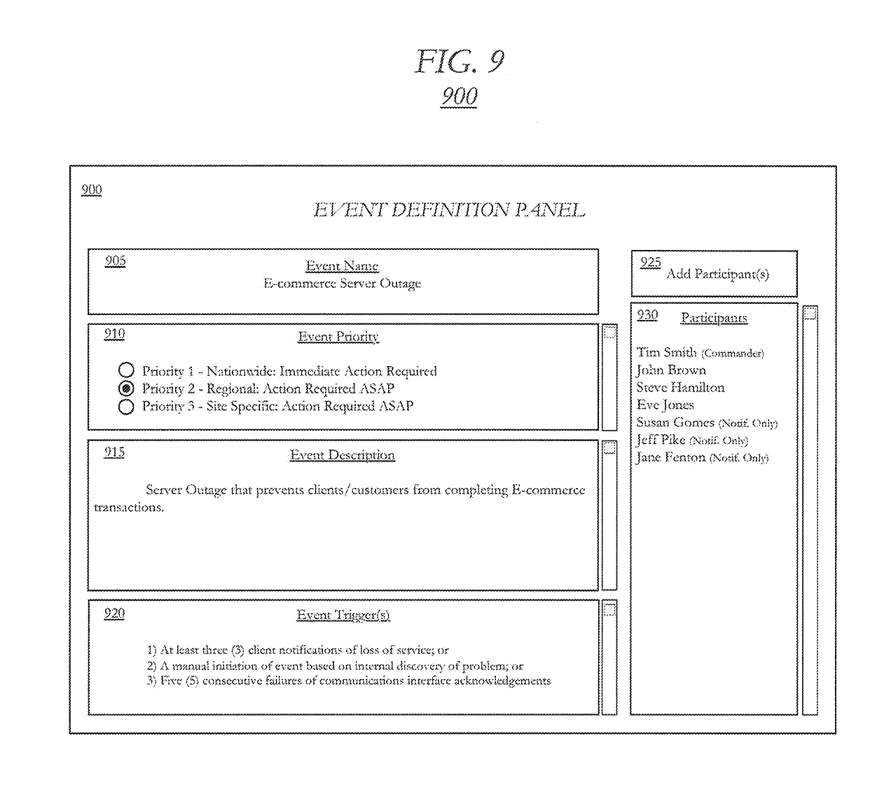

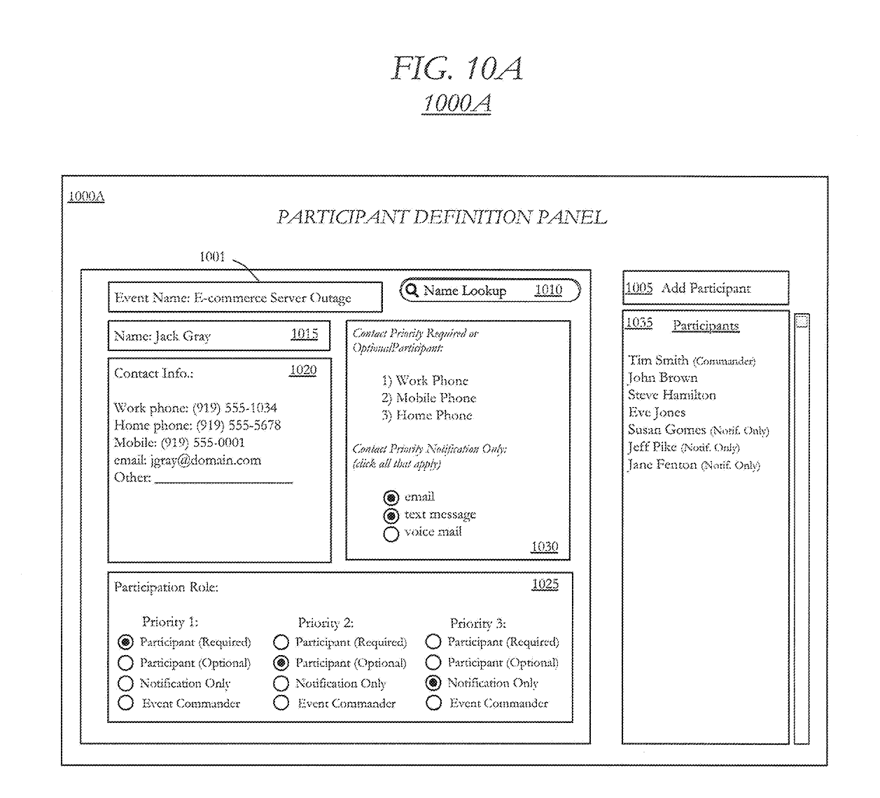

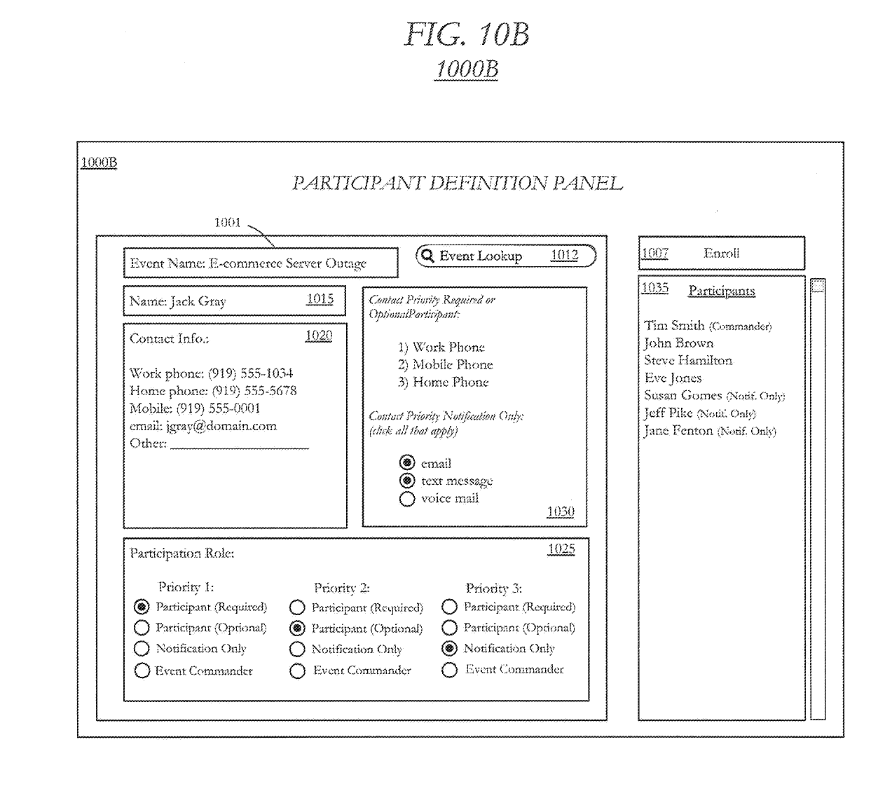

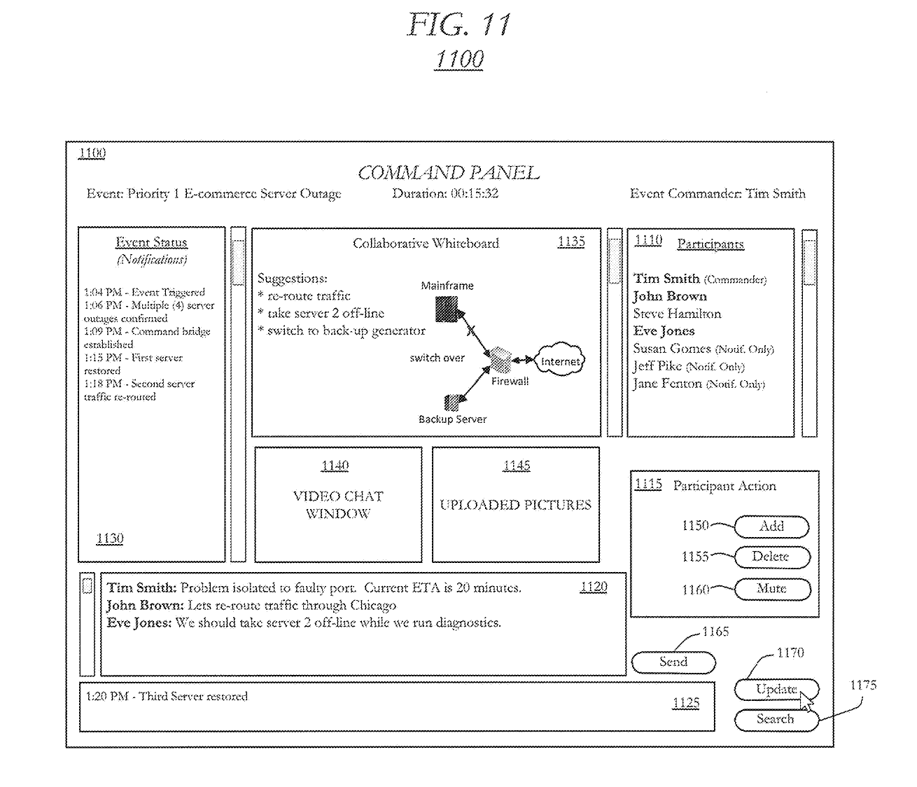

The new event component 810 when launched may present an event definition panel screen as shown in FIG. 9. Similarly, the edit existing event component 820 when launched may present the same event definition panel screen as shown in FIG. 9. The add participant component 830 when launched may present a participant definition panel screen as shown in FIG. 10B that permits a user to self-enroll in one or more events. The trigger event component 840 when launched may open a tab (not shown) querying the user which event to trigger. The user may then select an event to manually trigger such that the EEMS server 200 recognizes the trigger and launches the event. The event may be manually triggered by anyone with access to the system not just the event commander for that event or event participants. In this way, anyone that recognizes an emergency event may trigger a response similar to pulling a fire alarm in a building. The manage event component 850 when launched may present a command panel screen as shown in FIG. 11. The review event log component 860 when launched may open a tab (not shown) that allows a user to select a stored event and review the response and resolution. In some embodiments, the event response may be annotated with post event comments designed to help in the future if a similar event occurs and is accessed in real-time to help guide a resolution to the future event. The generate event report component 870 when launched may open a tab (not shown) that allows a user to select an event and generate a report summarizing the event, activity that occurred during the event, suggestions made during the event, resolution of the event, or any combination thereof. The report may be analyzed and data may be used to fine tune responses to future events or take precautionary steps to avoid future similar events.

FIG. 9 illustrates an embodiment of a computer screen image for defining an event. The event definition panel 900 may be displayed when a user selects either the new event component 810 or edit existing event component 820 from the main window 800 of FIG. 8. The event definition panel 900 may include sections, frames, or areas on the display dedicated to different tasks or functions. For example, the event definition panel 900 may include sections for functions including event name 905, event priority 910, event description 915, event triggers 920, adding participants 925, and listing participants 930.

The event name function 905 is a required field and may be designed to prompt a user for a unique label identifier (e.g., event name) to distinguish this event from all others. The user will be able input event name data directly into a reserved space. In this example, the user has entered “E-commerce Server Outage” as the event name. No two events can have the exact same event name. The event priority function 910 is designed to characterize the severity of the event which may affect the type of response to the event. For instance, an “E-commerce Server Outage” may be localized or wide-spread. A wide-spread “E-commerce Server Outage” may be characterized as a priority one event requiring immediate action. A priority two “E-commerce Server Outage” may be characterized as regional in scope and may not require as strong a response as a priority one “E-commerce Server Outage”. Similarly, a priority three “E-commerce Server Outage” may be site=specific and may not require as much attention as either a priority one or priority two “E-commerce Server Outage” event. The EEMS 100 allows for prioritizing the same underlying event based on its severity such that each event, while similar in nature, does not have a one size fits all response.

The event description function 915 allows a user to include a narrative describing the circumstances or problems associated with the unplanned emergency situation. For example, for the event name “E-commerce Server Outage” the description may characterize the event as a server outage that prevents clients/customers from completing E-commerce transactions.

The event triggers function 920 is a required function that sets out the triggering conditions that precipitate or cause the event to occur. These conditions, when met, cause the EEMS 100 to automatically launch an event management response. There may be multiple triggers wherein any one of which is sufficient to cause an event management response. For example, there are three (3) triggers shown in the “E-commerce Server Outage” example of FIG. 9. The first trigger listed references at least three (3) different client notifications of loss of service. This may refer to a client feedback reporting mechanism via telephone or web-site contact form, or the like. The second trigger references a manual triggering of the event based on an internal discovery of the problem. It is anticipated that all events will have a manual trigger similar to pulling a fire alarm. That way, anyone internal to the organization could trigger an event management response upon discovery of a problem that may not be necessarily covered under one of the other triggering conditions. The third trigger references five (5) consecutive internal communications acknowledgement failures. For example the servers responsible for carrying out E-commerce transactions may be in constant communication with other servers (e.g., third party payment processing systems). If these communications are interrupted it could cause an outage sufficient to trigger an event management response. The selection of five (5) consecutive failures is merely illustrative and should not be considered limiting. Moreover, all the triggers discussed above are merely illustrative in relation to a contrived event and should not be construed as limiting to the embodiments described herein. In addition, the triggers are not necessarily listed in any given order of importance since detection of any one of the triggers may be sufficient to launch an event management response.

The add participant(s) function 925 allows a user to launch a new tab/window in which participants may be added to the event. This function is more fully described below with respect to FIGS. 10A & 10 B. The participant list 930 provides a listing of all participants and their roles that are associated with the event.

One of the features of the embodiments described herein is the ability of the EEMS 100 to be tailored to fit the need and operations of an unlimited number of enterprises and emergency events. Thus, those of ordinary skill in the art may readily customize the event definition panel 900 to include or omit other functions and present the functions in a manner different than that presented in FIG. 9. Such modifications would not necessarily depart from the scope of the present embodiments.

FIG. 10A illustrates an embodiment of a computer screen image for adding a participant to an event. The participant definition panel 1000A may be displayed when a user selects the “add participant function” 925 from the event definition panel 900 of FIG. 9. The participant definition panel 1000A may include sections, frames, or areas on the display dedicated to different tasks or functions. For example, the participant definition panel 1000A may include sections for functions including event name 1001, name lookup 1010, name 1015, contact information 1020, participation role 1025, contact priority information 1030, add another participant 1005, and a listing of participants 1035.

The event name function 1001 lists the event name for which this participant will be associated. In following through with the example of FIG. 8, the event name is shown as “E-commerce Server Outage”. This field may be automatically filled in by the EEMS 100 since the participation definition panel 1000A was launched from within the event definition panel 900 in which the event name was already defined. The name lookup function 1010 allows a user to type the name of a desired participant (or display a pull down type list of names to select from). Once a name is selected from the name lookup function 1010 it is automatically placed in the name field 1015. Alternatively, a user may directly type the name of a participant in the name field 1015 bypassing the name lookup function 1010. Once the name of the participant has been entered, the EEMS may access a contact profile database for the participant to extract various modes of contacts and associated telephone numbers or email addresses. If the contact profile is incomplete, the user may input specific contact data for the participant in the contact information field 1020. The participation role function 1030 allows a user to define the role of the participant being added to the event. For example, there may be four types participant roles including event commander, participant (required), participant (optional), and notification only. Moreover, the participant's role may be different depending on the severity or priority of the event. In the example give, Jack Gray is a required participant for a priority one event, an optional participant for a priority two event, and a notification only participant for a priority three event. The contact priority field 1030 is designed to instruct the EEMS 100 how to contact the participant upon triggering of the event. For example, Jack Gray shall be contacted first by attempting his work phone number followed by his mobile number then his home number when his participation role is designated required or optional. When his participation role is designated as notification only, he will be contacted via email and text message when status updates are posted by the event commander during the event management response.

Upon completion of adding a participant (e.g., Jack Gray in this example), that participants name and role will be added to the participant list 1035. Should the user wish to add another participant he or she may select the “add participant” function 1005 to restart the process.

FIG. 10B illustrates another embodiment of a computer screen image for adding a participant to an event. This may be referred to as the self-enrollment option in which users may add themselves to events as opposed to an event commander adding the user as a participant. The participant definition panel 1000B may be displayed when a user selects the “add participant component” 830 from the EEMS main window 800 of FIG. 8. The participant definition panel 1000E may include sections, frames, or areas on the display dedicated to different tasks or functions. For example, the participant definition panel 1000E may include sections for functions including event name 1001, event lookup 1012, name 1015, contact information 1020, participation role 1025, contact priority information 1030, enroll 1007, and a listing of participants 1035.

The event name function 1001 lists the event name for which this participant will be associated. This field may be filled using the event lookup function 1012. The event lookup function 1012 allows a user to type the name of a desired event (or display a pull down type list of events to select from). Once an event is selected from the event lookup function 1012 it is automatically placed in the event name field 1001. Alternatively, a user may directly type the name of an event in the event name field 1001 bypassing the event lookup function 1012. Once the event name and participant's name (e.g., current user) has been entered in fields 1001 and 1015 respectively, the EEMS may access a contact profile database for the participant to extract various modes of contacts and associated telephone numbers or email addresses. If the contact profile is incomplete, the user may input specific contact data for the participant in the contact information field 1020. The participation role function 1030 allows a user to define the role of the participant being added to the event. For example, there may be four types participant roles including event commander, participant (required), participant (optional), and notification only. Moreover, the participant's role may be different depending on the severity or priority of the event. In the example give, Jack Gray has identified himself as a required participant for a priority one event, an optional participant for a priority two event, and a notification only participant for a priority three event. The contact priority field 1030 is designed to instruct the EEMS 100 how to contact the participant upon triggering of the event. For example, Jack Gray shall be contacted first by attempting his work phone number followed by his mobile number then his home number when his participation role is designated required or optional. When his participation role is designated as notification only, he will be contacted via email and text message when status updates are posted by the event commander during the event management response.

Once the user (e.g., Jack Gray in this example), has filled in the requisite participation information, he may select the enroll function 1007 that will place him on the participant list 1035 for the designated event.

FIG. 11 illustrates an embodiment of a computer screen image for a command panel 1100 for use in managing an event. The command panel 1100 is for use by the event commander and may be displayed when a user directly selects the “manage event component” 850 or indirectly when another user selects the “trigger event component” 840 from the EEMS main window 800 of FIG. 8. The command panel 1100 may also be displayed on the event commander's display when the EEMS 100 detects the triggering of an event.

The command panel 1100 may include sections, frames, or areas on the display dedicated to different tasks or functions. For example, the command panel 1100 may include sections for functions including participants 1110, participant action 1115, real-time data 1120, status update 1125, event status 1130, a collaborative whiteboard 1135, a video chat 1140, and a section for uploaded pictures 1145. The top of the command panel 1100 may also include some general event information such as, but not limited to, the name/priority of the event, the duration of the event since the triggering condition(s), and the name of the event commander.

The participants section 1110 provides the event commander with a list of participants that are assigned to the event as well as the role of each participant. The list may be typically headed by the event commander followed by those participants designated as required followed by optional participants and finally notification only participants. The participants section 1110 may also give the current connection status of each participant. In the example shown in FIG. 11, certain names are bolded to indicate that they are connected to the communications bridge that was established at the triggering of the event. Names that are not bolded either are not required or have not yet been able to establish a connection. The EEMS 100 will continue attempting to establish a connection with required participants in a background task. It should be noted that the use of bold/not bold is merely illustrative. Those of ordinary skill in the art may design a feature that distinguishes from connected and not connected participants that is different than that just described. For instance, connected participants may be illustrated in a different color or shading than non-connected participants. In another embodiment, connected participants may be displayed in all capital letters while non-connected participants may be displayed in all lowercase letters. The embodiments described above are not intended to be limiting.

The event commander, via the command panel 1100, may also have discretion during an event to take additional participant action 1115 including adding a (previously un-associated) participant 1150 to the event, deleting a participant 1155 from the event, and muting a participant 1160 during the event (e.g., if that participant's environment is so noisy as to be disruptive to the communications bridge).

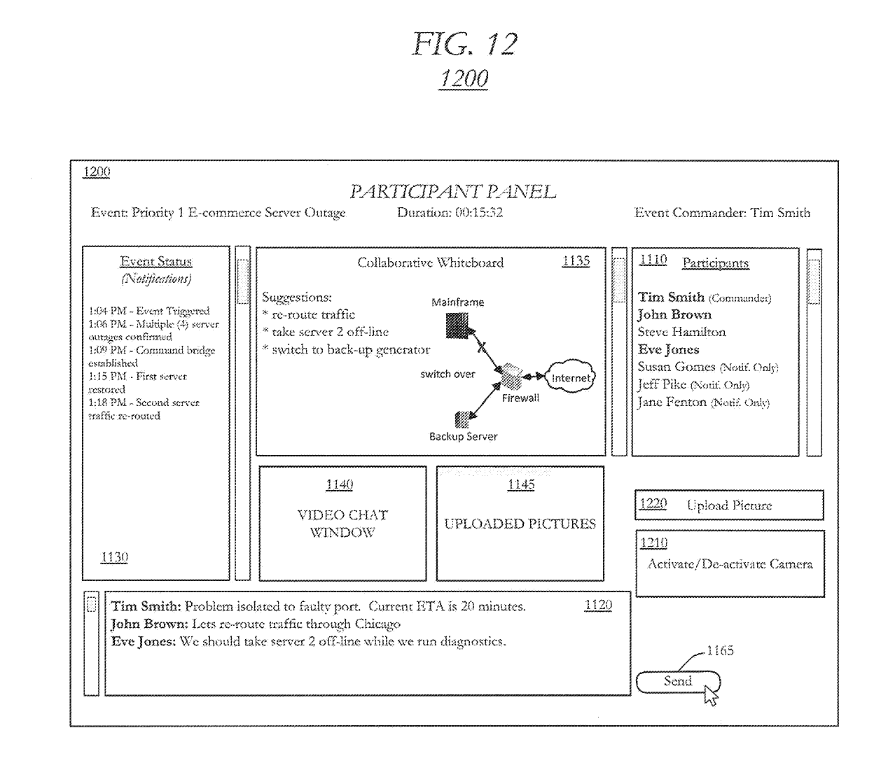

Another feature of the command panel 1100 may be the real-time data section 1120. The real-time data section 1120 is similar to a group chat function in which any participant connected to the bridge may provide data input that will appear in the designated portion of the command panel 1100 display. As will be shown in FIG. 12, the same section is included in the participant panel 1200. Thus, any participant may send data to the EEMS 100 and it will be displayed, in real-time, on the command panel 1100 and every other participant's panel 1200. This feature allows for real-time group communication for troubleshooting suggestions for resolving the event.

Another feature reserved for the command panel 1100 may be the status update section 1125. The status update section 1125 is an input means for use by the event commander to post real-time status updates that pertain to the event. In the example of FIG. 11, the phrase “Third server restored” along with a time stamp of 1:20 PM is shown within the status update section 1125. The event commander may then click on the “update” button 1175 to enter the status update into the event status section 1130. The event status section 1130 may serve as the official source of the event status.

Another feature of the EEMS 100 may be the collaborative whiteboard section 1135. The collaborative whiteboard section 1135 is space reserved on both the command panel 1100 and participant panel 1200 in which participants can add text, sketches, images, and the like in a collaborative manner for all participants to see. The user may move their cursor within the allocated display space and type or can drag and drop other data, sketches, images, etc. . . . into the space. The space may be touch screen enabled such that a participant could use a stylus to draw directly on the white board space. The collaborative whiteboard section 1135 may be expandable by simply scrolling downward. That way, additional text and/or data may be added to the collaborative whiteboard section 1135 without fear that there is not enough space left on the display. In one embodiment, only the event commander can erase anything on the collaborative whiteboard section 1135.

Another feature of the EEMS 100 may be the video chat section 1140 that allows the participant currently speaking to occupy the video chat section 1140 provided the end user communication device being used by the participant supports video functionality. The event commander may have the discretion to control which participant including himself or herself occupies the video chat section 1140.

Another feature of the EEMS 100 may be the uploaded pictures section 1145 that allows the participant to take and upload pictures to the command panel 1100 and participant panel 1200. This may be especially useful if one of the participants is on site where a problem is and can share images with those participants that are remotely located. Multiple pictures may be uploaded and arranged in a tab format. In one embodiment the event commander may choose a default picture to be displayed in the uploaded pictures section 1145 while each participant may control their own participant panel 1200 to display the uploaded pictures that are of current interest to them.

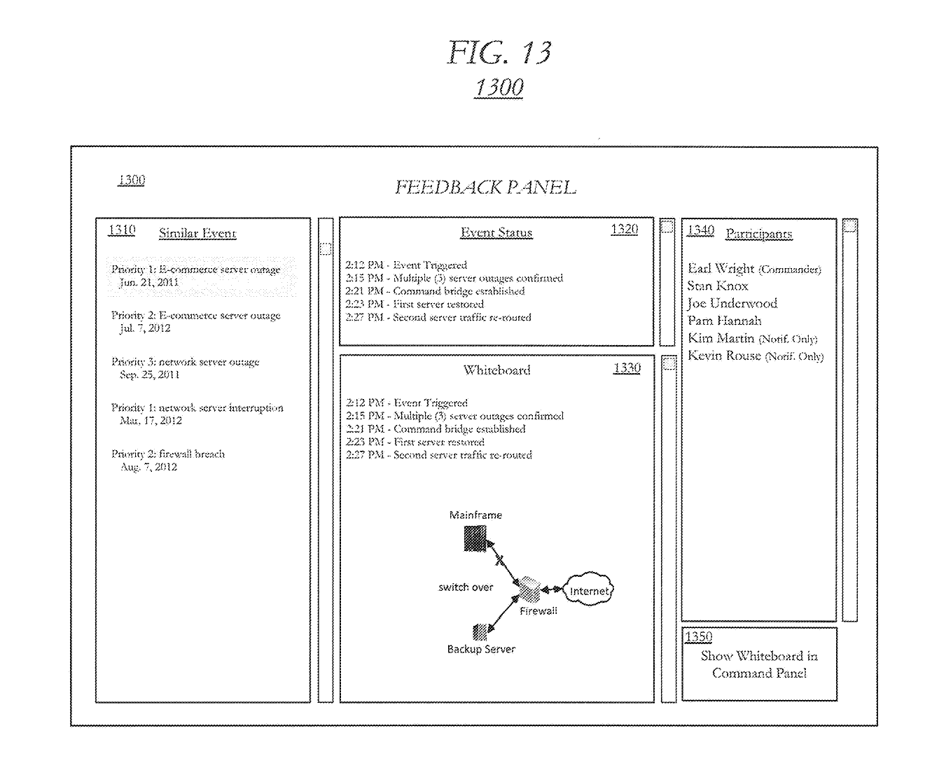

Another feature of the EEMS 100 may be the search button 1175 on the command panel 1100. The search button 1175 may be used by the event commander to access a database of previously stored events, their triggers, and the data input during their event management and the resolution of the event. The event commander may perform such a search in an effort to find past events that are very similar to the present event with the idea of determining whether the actions taken during the previous event could be helpful in the present event. When the event commander clicks the search button 1175, the EEMS 100 will perform a search comparing the circumstances and data of the present event against the circumstances and data of previous events. A search results page may be opened in another tab or window that lists the previous events in a relevance ranked order as they pertain to the present event. The event commander may then select one of the previous events. The selection will launch a feedback panel 1300 (See, FIG. 13) similar to the command panel 1100. The event commander may then review and or share the feedback panel 1300 with other participants. For instance, the event commander could post a link to the relevant feedback panel for participants to access on their own participant panel 1200.

Upon resolution or conclusion of an event, the data pertaining to the event may be stored for future use and analysis. Post event analysis may include event report generation and annotation. By storing the event and its associated data, future events may be mitigated when they occur by accessing the steps and actions taken to resolve this event. This is a type of feedback function previously mentioned and more fully described below.

FIG. 12 illustrates an embodiment of a computer screen image for a participant panel 1200 for use in managing an event. The participant panel 1200 is for use by event participants and may be displayed when a participant directly selects the “manage event component” 850 or indirectly when another user selects the “trigger event component” 840 from the EEMS main window 800 of FIG. 8. The participant panel 1200 may also be displayed on the participant's display when the EEMS 100 connects the participant to the communications bridge.

The participant panel 1200 may include many of the same sections, frames, or areas on the display dedicated to different tasks or functions as the command panel 1100. For example, the participant panel 1200 may include the same sections for functions as the command panel 1100 including participants 1110, real-time data 1120, event status 1130, a collaborative whiteboard 1135, a video chat 1140, and a section for uploaded pictures 1145. The top of the participant panel 1200 may also include some general event information such as, but not limited to, the name/priority of the event, the duration of the event since the triggering condition(s), and the name of the event commander. As these functions were fully described above they are not repeated here.

In addition to the aforementioned functions, the participant panel 1200 may also include an activate/de-activate camera button 1210 and an upload picture button 1220. The activate/de-activate camera button 1210 may turn on the end user communication device's camera or video recorder if that end user communications device is so equipped. The upload picture button 1220 may launch a process that prompts the user to attach an image file to a communications message intended for the uploaded pictures section 1145 of the command panel 1100 and the participant panel 1200.

FIG. 13 illustrates an embodiment of a computer screen image for a feedback panel 1300 for use in managing an event. As earlier described, the feedback panel may be representative of a stored previous event that a search determined is similar to the present event. The feedback panel 1300 may be arranged to show the search results 1310 for similar events on one side of the display. When the user selects one of the events in the search results (e.g., the first listed result in the present example as indicated by the shading of the event), the feedback panel 1300 may then populate the other portions of the display including the event status 1320, the collaborative whiteboard 1330, and the event participants 1340 with the relevant data of the previous event. The participants in the present event may peruse the previous event data in an attempt to troubleshoot the current event. For example, it is possible that an action taken in the prior event could lead to a resolution of the current event.

In one embodiment, as the amount of data for the current event increases, the search results for similar events may become more refined and relevant. Thus, the EEMS 100 may periodically re-perform the search to determine if the previous events should be re-ranked according to the relevance to the current event.

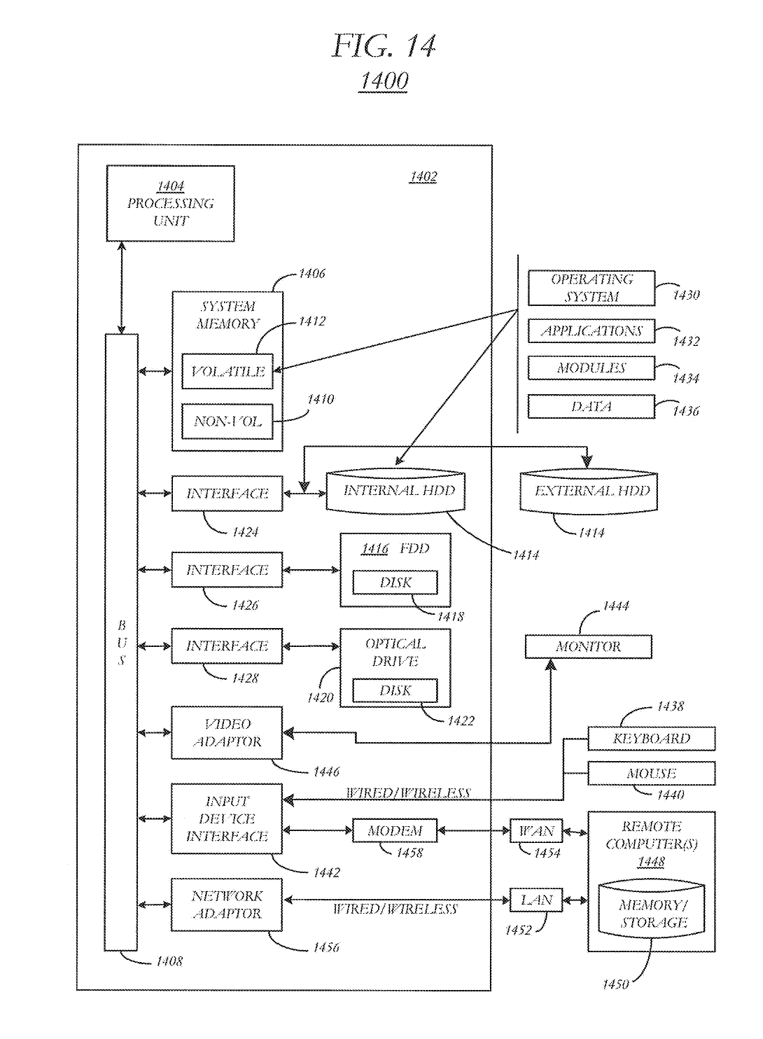

FIG. 14 illustrates an embodiment of an exemplary computing architecture 1400 suitable for implementing various embodiments as previously described. In one embodiment, the computing architecture 1400 may comprise or be implemented as part of an electronic device. The embodiments are not limited in this context.

As used in this application, the terms “system” and “component” are intended to refer to a computer-related entity, either hardware, a combination of hardware and software, software, or software in execution, examples of which are provided by the exemplary computing architecture 1400. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1400 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1400.

As shown in FIG. 14, the computing architecture 1400 comprises a processing unit 1404, a system memory 1406 and a system bus 1408. The processing unit 1404 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1404.

The system bus 1408 provides an interface for system components including, but not limited to, the system memory 1406 to the processing unit 1404. The system bus 1408 can be any of several types of bus structure that may further interconnect to a memory bus (with or without a memory controller), a peripheral bus, and a local bus using any of a variety of commercially available bus architectures. Interface adapters may connect to the system bus 1408 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1400 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1406 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 14, the system memory 1406 can include non-volatile memory 1410 and/or volatile memory 1412. A basic input/output system (BIOS) can be stored in the non-volatile memory 1410.

The computer 1402 may include various types of computer-readable storage media in the form of one or more lower speed memory units, including an internal (or external) hard disk drive (HDD) 1414, a magnetic floppy disk drive (FDD) 1416 to read from or write to a removable magnetic disk 1418, and an optical disk drive 1420 to read from or write to a removable optical disk 1422 (e.g., a CD-ROM or DVD). The HDD 1414, FDD 1416 and optical disk drive 1420 can be connected to the system bus 1408 by a HDD interface 1424, an FDD interface 1426 and an optical drive interface 1428, respectively. The HDD interface 1424 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1410, 1412, including an operating system 1430, one or more application programs 1432, other program modules 1434, and program data 1436. In one embodiment, the one or more application programs 1432, other program modules 1434, and program data 1436 can include, for example, the various applications and/or components of the system 100.

A user can enter commands and information into the computer 1402 through one or more wire/wireless input devices, for example, a keyboard 1438 and a pointing device, such as a mouse 1440. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1404 through an input device interface 1442 that is coupled to the system bus 1408, but can be connected by other interfaces such as a parallel port, IEEE 1394 serial port, a game port, a USB port, an IR interface, and so forth.

A monitor 1444 or other type of display device is also connected to the system bus 1408 via an interface, such as a video adaptor 1446. The monitor 1444 may be internal or external to the computer 1402. In addition to the monitor 1444, a computer typically includes other peripheral output devices, such as speakers, printers, and so forth.

The computer 1402 may operate in a networked environment using logical connections via wire and/or wireless communications to one or more remote computers, such as a remote computer 1448. The remote computer 1448 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1450 is illustrated. The logical connections depicted include wire/wireless connectivity to a local area network (LAN) 1452 and/or larger networks, for example, a wide area network (WAN) 1454. Such LAN and WAN networking environments are commonplace in offices and companies, and facilitate enterprise-wide computer networks, such as intranets, all of which may connect to a global communications network, for example, the Internet.

When used in a LAN networking environment, the computer 1402 is connected to the LAN 1452 through a wire and/or wireless communication network interface or adaptor 1456. The adaptor 1456 can facilitate wire and/or wireless communications to the LAN 1452, which may also include a wireless access point disposed thereon for communicating with the wireless functionality of the adaptor 1456.

When used in a WAN networking environment, the computer 1402 can include a modem 1458, or is connected to a communications server on the WAN 1454, or has other means for establishing communications over the WAN 1454, such as by way of the Internet. The modem 1458, which can be internal or external and a wire and/or wireless device, connects to the system bus 1408 via the input device interface 1442. In a networked environment, program modules depicted relative to the computer 1402, or portions thereof, can be stored in the remote memory/storage device 1450. It will be appreciated that the network connections shown are exemplary and other means of establishing a communications link between the computers can be used.

The computer 1402 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A system, comprising:
a processor component;
a communications interface component operative on the processor component to establish a bridge connection among a plurality of communication devices;
an event definition component operative on the processor component to define the parameters of an event, the event indicative of an unplanned happening; and
an event management component operative on the processor component to recognize a triggering of the event and cause the communications interface component to establish the bridge connection among the plurality of communication devices upon the triggering of the event.

2. The system of claim 1, the event definition component operative on the processor component further operative to:
create a unique identifying label for the event;
determine a priority level for the event;
associate at least one condition that would trigger the event; and
determine a plurality of participants associated with the event.

3. The system of claim 2, the event definition component operative on the processor component further operative to:
assign a participation role for each participant for each priority level of the event;
determine at least one contact number for each participant, the contact number associated with a communications device; and
when a participant has more than one contact number, determining a priority contact order for the contact numbers.

4. The system of claim 3, the participant role chosen from a set comprising a required participant, an optional participant, an event commander, and a notification only participant.

5. The system of claim 4, wherein contact options for a notification only participant include email, text message, and voice mail.

6. The system of claim 2, the event definition component operative on the processor component further operative to:
receive participant self enrollment data for an event, the self enrollment data comprising the unique identifying label for the event, a participation role for each participant for each priority level of the event, at least one contact number, and when there are more than one contact numbers, a priority contact order for the contact numbers.

7. The system of claim 2, the event management component operative on the processor component further operative to:
receive real-time data from participants, the data pertaining to the event;
receive real-time suggestions from participants, the suggestions pertaining to a resolution of the event;
create real-time status updates pertaining to a resolution of the event; and
cause the display of the real-time data from participants, real-time suggestions from participants and real-time status updates on a display accessible to all participants utilizing a communications device that includes a display.

8. The system of claim 7, further comprising:
a feedback component operative on the processor component to:
compare previous events stored in memory to the event;
determine if any previous events are similar to the event;
cause the display of a relevance ranked list of previous events based on similarity to the event;
receive a selection of one of the listed previous events; and
cause the display of stored suggestions and data pertaining to a resolution of the selected previous event.

9. The system of claim 8, the feedback component operative on the processor component further operative to:
compare previous events stored in memory to the event each time a new real-time suggestion is received or real-time status update is generated; and
cause the display of an updated relevance ranked list of previous events based on similarity to the event.

10. The system of claim 1, the communications devices including at least one from a set comprising mobile terminals, Voice-over Internet Protocol (VoIP) phones, personal computers, laptop computers, tablet computers, and Plain Old Telephone Service (POTS) phones.

11. At least one non-transitory computer-readable storage medium comprising instructions that, when executed, cause a system to:
define the parameters of an event, the event indicative of an unplanned happening;
recognize a triggering of the event; and
launch a bridge connection among a plurality of communication devices upon the triggering of the event.

12. The non-transitory computer-readable storage medium of claim 11, comprising instructions that when executed cause the system to:
create a unique identifying label for the event;
determine a priority level for the event;
associate at least one condition that would trigger the event; and
determine a plurality of participants associated with the event.

13. The non-transitory computer-readable storage medium of claim 12, comprising instructions that when executed cause the system to:
assign a participation role for each participant for each priority level of the event;
determine at least one contact number for each participant, the contact number associated with a communications device; and
when a participant has more than one contact number, determining a priority contact order for the contact numbers.

14. The non-transitory computer-readable storage medium of claim 13, the participant role chosen from a set comprising a required participant, an optional participant, an event commander, and a notification only participant.

15. The non-transitory computer-readable storage medium of claim 14, wherein contact options for a notification only participant include email, text message, and voice mail.

16. The non-transitory computer-readable storage medium of claim 12, comprising instructions that when executed cause the system to:
receive participant self enrollment data for an event, the self enrollment data comprising the unique identifying label for the event, a participation role for each participant for each priority level of the event, at least one contact number, and when there are more than one contact numbers, a priority contact order for the contact numbers.

17. The non-transitory computer-readable storage medium of claim 12, comprising instructions that when executed cause the system to:
receive real-time data from participants, the data pertaining to the event;
receive real-time suggestions from participants, the suggestions pertaining to a resolution of the event;
create real-time status updates pertaining to a resolution of the event; and
cause the display of the real-time data from participants, real-time suggestions from participants and real-time status updates on a display accessible to all participants utilizing a communications device that includes a display.

18. The non-transitory computer-readable storage medium of claim 17, comprising instructions that when executed cause the system to:
compare previous events stored in memory to the event;
determine if any previous events are similar to the event;
cause the display of a relevance ranked list of previous events based on similarity to the event;
receive a selection of one of the listed previous events; and
cause the display of stored suggestions and data pertaining to a resolution of the selected previous event.

19. The non-transitory computer-readable storage medium of claim 18, comprising instructions that when executed cause the system to:
compare previous events stored in memory to the event each time a new real-time suggestion is received or real-time status update is generated; and
cause the display of an updated relevance ranked list of previous events based on similarity to the event.

20. The non-transitory computer-readable storage medium of claim 11, the communications devices including at least one from a set comprising mobile terminals, Voice-over Internet Protocol (VoIP) phones, personal computers, laptop computers, tablet computers, and Plain Old Telephone Service (POTS) phones.
